(19) United States
(12) Patent Application Publication
(10) Pub. No.: US 2026/0145773 A1
(43) Pub. Date: May 28, 2026

(54) WINDOW UNIT FOR AIRCRAFT, AIRPORT SURVEILLANCE SYSTEM

(71) Applicant: Airbus Operations GmbH, HAMBURG (DE)

(72) Inventor: Sven-Olaf BERKHAHN, HAMBURG (DE)

(21) Appl. No.: 19/401,554

(22) Filed: Nov. 26, 2025

(30) Foreign Application Priority Data
Nov. 28, 2024 (DE) 102024135253.1

(51) Int. Cl. B64C 1/14; B64D 43/00; B64D 47/08; H04N 7/18

(52) U.S. Cl. CPC B64C 1/1492; B64D 43/00; B64D 47/08; H04N 7/181

(57) ABSTRACT

A window unit for aircraft that has an outer pane, an inner pane, and a camera. The inner pane is arranged between the outer pane and the camera. In addition, a field of view of the camera is aligned only through a partial area of the inner pane. The inner pane includes an arrangement of light-reflecting inner-pane-internal material, so that incident light rays through the outer pane can be partially guided from a coupling-in point on a first outer side of the inner pane, which faces the outer pane, to a coupling-out point on a second outer side of the inner pane, which faces an interior of an aircraft in which the window unit is arranged and which is located in the partial area of the inner pane. Also, an airport surveillance system for aircraft, and an aircraft.

### CROSS-REFERENCE TO RELATED APPLICATIONS

This application claims priority to German Patent Application No. 102024135253.1, filed on Nov. 28, 2024, the entire disclosure of which is incorporated herein by way of reference.

### FIELD OF THE INVENTION

The present invention relates to a window unit for aircraft, in particular for airplanes, as well as an airport surveillance system for aircraft, in particular for airplanes.

### BACKGROUND OF THE INVENTION

Aircraft, in particular airplanes, are frequently used for recurring flight activities, whereby after short stays on the ground, the next flight mission is already pending. The short stays on the ground are intensively used to check the aircraft and prepare it for the next flight mission.

In the case of airplanes, in particular commercial airplanes, this may range from refueling operations, handling of loading operations of cargo to be transported, usual quality routines, up to de-icing operations.

In this respect, numerous activities can be observed around the commercial airplane during the stay on the ground. In doing so, specialists and equipment are equally involved, whereby an overview of these activities as well as any other activities may be limited from a window unit of the commercial airplane, for example from a window unit in the cockpit area.

However, it is desirable that, for example, the flight personnel can quickly obtain an overall view of currently performed activities, in order to be able, for instance, to estimate time management regarding ground activities.

An all-round view around the airplane, in particular from the cockpit, is currently only possible to a limited extent. Technical means would therefore be desirable that would help to proactively obtain an overview from the airplane during the short stays on the ground.

An all-round view around the airplane, in particular from the cockpit, can also be helpful during possible evacuation operations of passengers from the airplane. Currently, routines are known which provide that the cabin crew checks independently and without further technical aids whether sufficient space is available outside the airplane for deploying emergency slides. If the time required for this could be saved, the cabin crew could use it for other important activities.

First, existing solutions from the prior art already provide camera systems that are installed directly in the existing window units. However, they reduce an existing field of view, so that these window units are only available for normal use to a limited extent. Such a restricted field of view may also be perceived as disturbing by some passengers. In addition, it is also helpful for the cabin crew to have an immediate free field of view from the respective windows at any time, in order to be able to quickly and directly gain an impression of an external situation at each window unit of the airplane at which the cabin crew is currently located.

### SUMMARY OF THE INVENTION

Against this background, it is an object of the present invention to provide a window unit for aircraft, in particular airplanes, and an airport surveillance system for aircraft, in particular airplanes, which at least partially overcomes the disadvantages mentioned above.

This object is achieved by a window unit for aircraft having the features of one or more embodiments described herein and by an airport surveillance system for aircraft having the features of one or more embodiments described herein.

According to the invention, a window unit for aircraft, in particular airplanes, is provided, which comprises an outer pane, at least one inner pane, and at least one camera unit. The at least one inner pane is arranged between the outer pane and the at least one camera unit, wherein a field of view of the at least one camera unit is aligned only through a partial area of the at least one inner pane. In addition, the at least one inner pane comprises an arrangement of light-reflecting inner-pane-internal material, such that incident light rays through the outer pane are partially guidable from at least one coupling-in point on a first outer side of the at least one inner pane, which faces the outer pane, to at least one coupling-out point on a second outer side of the at least one inner pane, which faces an interior of an aircraft in which the window unit is arranged and which is located in the partial area of the at least one inner pane.

Furthermore, according to the invention, an airport surveillance system for aircraft, in particular for airplanes, is provided, which comprises a control unit with control program and at least one inventive window unit coupled to the control unit with control program.

Furthermore, according to the invention, an airplane is provided which comprises at least one inventive window unit or an inventive airport surveillance system.

An idea of the present invention is therefore to provide a window unit and an airport surveillance system respectively for aircraft, in particular airplanes, which in each case enable an all-round view around the aircraft, for example in the form of a commercial airplane, and at the same time enable this all-round view around the aircraft independently of location, without the direct fields of view of window units being restricted.

In comparison with the usual installation of exterior cameras in airplane cabin windows with standard glass panes or the like, in which the camera always covers a part of the window and thus restricts a view to the outside for passengers and cabin crew, the invention presented enables the installation of a camera unit outside the direct viewing area (transparent area) of a window unit.

Thus, in an advantageous manner, a full window size of the window unit remains available. At the same time, the presented invention enables a location-independent overview around the aircraft. An immediate advantage thus consists in that, for example, a specialist controlling the aircraft, for instance in the form of a pilot, can obtain an all-round view around the aircraft from one location, for example from the cockpit, by receiving and viewing respective signals from the camera units directly.

The above-mentioned advantages apply, insofar as transferable, also to the presented airfield surveillance system for aircraft, in particular for airplanes, as well as to the presented airplane.

The presented airport surveillance system can also be referred to as a camera surveillance system for an airplane.

According to a further embodiment of the invention, it is provided that the at least one inner pane has a total surface area which is larger than a total surface area of the outer pane, and that the partial area of the inner pane is provided in a region of the at least one inner pane that does not overlap the total surface area of the outer pane.

This clearly defined region therefore offers the advantage of selecting the provided camera unit according to the size of the additional partial area, so that, depending on the field of application, any camera unit technology can be provided without restriction in dimensions, such as an existing optical unit or the like.

According to a further embodiment of the invention, it is provided that the at least one camera unit is selected from: an image-forming digital camera unit, a thermal-image-generating camera unit, or an infrared-image-generating camera unit.

In this way, a particularly flexible window unit can be provided for respective requirements of the most diverse application fields.

According to a further embodiment of the invention, it is provided that the at least one inner pane and the at least one camera unit are arranged in a common frame structure, so that the at least one camera unit is positionable fixed in place relative to the at least one inner pane.

A stable window unit, particularly with regard to the provided camera unit, offers the advantage that even during longer or more demanding periods of use of the aircraft in which the window unit is arranged, a reliable functionality of the window unit can always be ensured. The arrangement of light-reflecting inner-pane-internal material can thus, from the beginning, be optimally aligned with the provided camera unit and vice versa, whereby the common frame structure can ensure an always flawless technical feasibility.

According to a further embodiment of the invention, it is provided that the at least one inner pane, in addition to the arrangement of light-reflecting inner-pane-internal material, comprises at least one plastic, in particular at least polymethyl methacrylate, or at least one glass composite, or at least one plastic, in particular at least polymethyl methacrylate, and at least one glass composite.

Depending on the material selected for the inner pane, either a particularly cost-effective or a window unit designed for special technical purposes can advantageously be produced. In particular, composites made of both base materials, plastic and glass, can be provided, so that, on the one hand, safety aspects and, on the other hand, the technical advantages of the present invention can be especially well observed. The choice of materials and combinations thereof are always advantageously selected in such a way that the arrangement of light-reflecting inner-pane-internal material can be integrated into the inner pane in the best possible way.

According to a further embodiment of the invention, it is provided that the at least one inner pane has a total surface area which is larger than a cut-out region of an aircraft fuselage of the aircraft in which the window unit is arranged for the outer pane, and that the partial area of the inner pane is provided in a region of the at least one inner pane that does not overlap this cut-out region.

Thus, sufficient space can be created in order to best position the provided camera unit, so that a free field of view and a reliably functioning window unit can be produced. In this way, sufficient space can also be provided for several, for example technically different, camera units, so that a particularly flexibly usable window unit can be provided.

According to a further embodiment of the invention, it is provided that the airport surveillance system comprises at least one mobile display unit, so that captured image information from the at least one camera unit of the at least one window unit can be displayed user-defined.

An optimal technical coordination of the provided mobile display unit with the at least one provided camera unit can thus advantageously be ensured, so that a particularly reliable transmission and viewing of the collected information material from the at least one provided camera unit via the mobile display unit is possible.

According to a further embodiment of the invention, it is provided that the control unit with control program is designed to effect, depending on an evaluation of captured image information of the at least one camera unit from the at least one window unit, by means of the control program, at least one output, in particular an acoustic, written, or an acoustic and written output, on the mobile display unit.

An operator of the inventive airport surveillance system is thus advantageously given the possibility, in addition to personal individual assessment in the course of evaluating the captured image information in any conceivable forms of embodiment, to additionally include a technically provided evaluation from the system itself, for instance for decision-making processes.

According to a further embodiment of the invention, it is provided that a number of the at least one camera unit of the at least one window unit and a positioning in an aircraft in which the airport surveillance system is arranged, of the at least one camera unit of the at least one window unit, are in each case designed such that a 360° all-round view around the aircraft can be provided for a user. The advantages mentioned above can thus be achieved even better. In particular, the presented system for aircraft can provide, per provided window unit, more than one camera unit accordingly, so that the 360° all-round view can be fully provided.

### BRIEF DESCRIPTION OF THE DRAWINGS

In the following, the present invention is explained in more detail with reference to exemplary embodiments illustrated in schematic figures:

FIG. 1 shows a schematic view of a window unit for aircraft, in particular for airplanes;

FIG. 2 shows a schematic detailed view of a partial area of a window unit for aircraft, in particular for airplanes;

FIG. 3 shows a schematic view of an airport surveillance system for aircraft, in particular for airplanes;

FIG. 4 shows a schematic view of an inventive airplane.

In the figures of the drawings, identical, functionally identical, and identically acting elements, features, and components are each provided with the same reference signs, unless otherwise indicated.

### DETAILED DESCRIPTION OF THE PREFERRED EMBODIMENTS

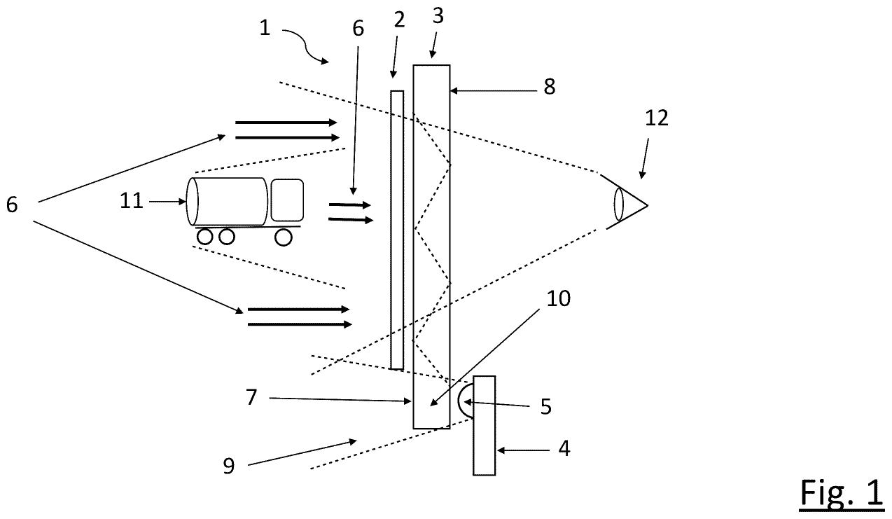

FIG. 1 shows a schematic view of a window unit (1) for aircraft, in particular for airplanes. In this schematic sectional view, a possible installation position of the inventive window unit (1) in a not further shown aircraft, for instance in the form of a commercial airplane, is shown.

It is thus conceivable that this window unit (1) is arranged in an associated aircraft fuselage of a commercial airplane, as is provided, for example, for conventional windows for commercial airplanes. In particular, it is conceivable that a depicted outer pane (2) of the window unit (1) is designed to be inserted essentially accurately fitting into a correspondingly cut-out area provided for these purposes in an aircraft fuselage.

With reference to the image plane, to the right of the outer pane (2), an inner pane (3) of the inventive window unit (1) of larger surface area is shown, wherein, in each case, at the top and bottom (again with reference to the image plane), this inner pane (3) protrudes beyond a total surface area of the outer pane (2). The way of this protrusion is merely exemplary in FIG. 1. It is also conceivable that both at the top and bottom, regions of the inner pane (3) protrude beyond the total surface area of the outer pane (2), wherein one of the two regions is larger in area, wherein, for example, a ratio is provided such that the lower region is twice as large as the upper region. Any further ratios are likewise conceivable.

The two panes (2, 3) are arranged substantially parallel to each other. It is conceivable that, in not further illustrated embodiments, a relative installation position of the two panes to each other and in relation to an orientation of a not further illustrated aircraft fuselage or the like can take any other variants which prove technically useful and appear necessary according to technical requirements.

The illustrated inner pane (3) comprises a not further illustrated arrangement of light-reflecting inner-pane-internal material, which may, for example, be inseparably integrated into a main glass material or the like of the inner pane (3).

Arrangements of several inner panes (3) provided for these purposes are also conceivable. Accordingly, it is conceivable that the window unit (1) in a not further illustrated variant comprises more than one inner pane (3). For example, two or three inner panes (3) could be provided, wherein both separate arrangements and composites of inner panes (3) are conceivable. In a not further illustrated variant, it is thus conceivable that two or five inner panes (3) are provided, wherein respective arrangements of light-reflecting inner-pane-internal material in the respective inner panes (3) are arranged relative to one another in such a way that the intended technical effect of the inventive window unit (1) is achievable.

In the lower region of the inner pane (3) (again referring to the image plane), a camera unit (4) of the inventive window unit (1) is shown in a greatly simplified manner, wherein an optics unit (5) of this camera unit (4) is oriented essentially in the direction of the inner pane (3).

Accordingly, the inner pane (3) is shown arranged between outer pane (2) and camera unit (4). It is conceivable that the optics unit (5) in the simplest case is provided only with a lens unit or even merely with an optical lens. It is also conceivable that the optics unit (5) can comprise several lens units or even more than one optical lens.

It is also conceivable that the window unit (1) in an embodiment not further shown comprises corresponding connections, so that the camera unit (4) and/or its optics unit (5) are designed to be controllable from a distance, for example from the location where the evaluation of the image information captured by the camera unit (4) takes place.

Furthermore, it is conceivable that, depending on the light conditions outside the aircraft in which the window unit (1) is installed, an at least partially automated adjustment process of the window unit (1) can be effected, so that image material to be transmitted from the camera unit (4) can always be provided to a user in the best possible quality. The image information generated by the at least one camera unit (4) can be transmitted to a user of the window unit (1) by means of conventional transmission techniques. Thus, simple transmission lines can be provided. Common wireless connection technologies or the like can also be employed.

The arrangement of light-reflecting inner-pane-internal material is provided in such a way that incident light rays (6) through the outer pane (2) can be partially guided from at least one coupling-in point on a first outer side (7) of the inner pane (3), which faces the outer pane (2), to at least one coupling-out point on a second outer side (8) of the inner pane (3), which faces a not further illustrated interior of an aircraft in which the window unit (1) is arranged and which is located in the partial area of the at least one inner pane (3).

In FIG. 1, an optical path of incident light rays (6) inside the inner pane (3) is shown schematically by a dashed line, wherein this optical path is produced by the provided arrangement of light-reflecting inner-pane-internal material in the inner pane (3). The coupling-in point is located in the upper third of the inner pane (3) on the first outer side (7), and the coupling-out point is located in the lower third of the inner pane (3) on the second outer side (8), so that ultimately the incident light rays (6) partially strike the camera unit (4).

The camera unit (4) is represented with a field of view (9) which is aligned only through a partial area (10) of the inner pane (3). In other words, the field of view (9) of the camera unit (4) is aligned only through this partial area (10) of the inner pane (3) and not through the outer pane (2), so that objects located outside the not further illustrated aircraft—for example, in the form of the refueling vehicle (11) shown in FIG. 1—can be detected by the camera unit (4) only because of the special arrangement of light-reflecting inner-pane-internal material in the inner pane (3).

At the same time, a depicted observer (12) (represented in FIG. 1 merely schematically by an eye) has an unobstructed view through the outer pane (2), since in the region of the inner pane (3) no disturbing objects are present owing to the inventive window unit (1).

The inner pane (3) with the arrangement of light-reflecting inner-pane-internal material can also be referred to as a smart-glass unit. In this connection, in all presented embodiments, comparable smart-glass panes can therefore be envisaged as a replacement or supplement for the inner pane (3) with the arrangement of light-reflecting inner-pane-internal material, so that the intended technical effects can be achieved and provided.

The inventive window unit (1) can, for example, be used in normal window-insertion regions in airplanes. Use in window-insertion regions of corresponding airplane doors or the like is also conceivable. Likewise, the inventive window unit (1) can be integrated into areas of a cockpit of an airplane provided for that purpose. The inventive window unit (1) enables, for example, an electronic exterior view for aircraft-such as conventional commercial airplanes-without thereby restricting direct visibility. In this connection, embodiments are also conceivable which provide that the control program (17) enables or is designed for a kind of virtual processing of the transmitted image information.

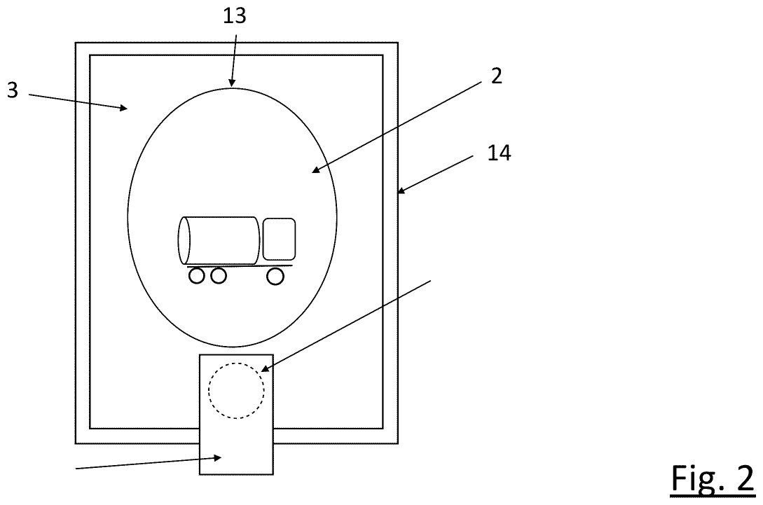

FIG. 2 shows a schematic detailed view of a partial area of a window unit (1) for aircraft, in particular for airplanes. In the center, a cut-out region (13) from a not further illustrated aircraft fuselage is shown, in which an outer pane (2) of the inventive window unit (1) is integrated or inserted or permanently installed.

An inner pane (3) which extends beyond the total surface area of the outer pane (2) in all directions is shown essentially rectangular in FIG. 2, wherein in a lower region (with reference to the image plane) a partial area (10) of the inner pane (3) is provided in which a camera unit (4) of the inventive window unit (1) is shown placed. This partial area (10) of the inner pane therefore does not overlap the total surface area of the outer pane (2) but protrudes beyond this total surface area of the outer pane (2) in a substantially parallel arrangement of the two panes (2, 3).

An optics unit (5) of the camera unit (4) is shown oriented such that it is provided overlapping in this partial area (10). The function already explained with reference to FIG. 1 applies equally to the schematic detailed view in FIG. 2 of a partial area of a window unit (1) for aircraft, wherein the aircraft can, for example, be a conventional commercial airplane or the like.

The inner pane (3) and the camera unit (4) are furthermore shown arranged on a frame structure (14) of the window unit (1), so that the camera unit (4) can be positioned fixed in place relative to the inner pane (3).

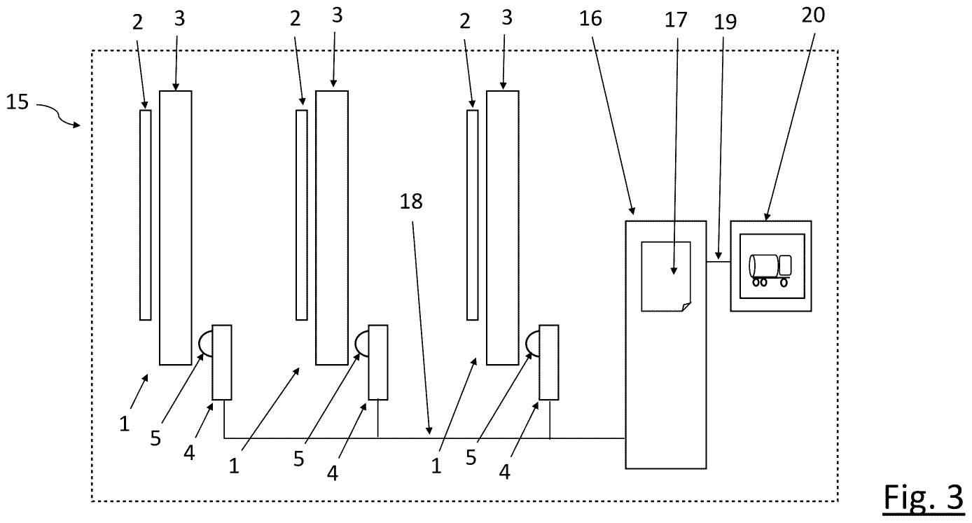

FIG. 3 shows a schematic view of an airport surveillance system (15) for aircraft, in particular for airplanes. This airport surveillance system (15) can, for example, be designed to be installed in a conventional commercial airplane and is shown with an associated control unit (16) having a control program (17).

The airport surveillance system (15), whose components are shown in FIG. 3 surrounded by a dashed line, in this embodiment comprises a total of three inventive window units (1).

In an embodiment not further illustrated, however, it is conceivable that the inventive airport surveillance system (15) comprises only one window unit (1) or more than three window units (1).

The three window units (1) are each shown with corresponding camera units (4), wherein these three depicted camera units (4) are provided coupled to the control unit (16) with control program (17) by means of a first connection line (18).

The control unit (16) with control program (17), in turn, is shown coupled by means of a second connection line (19) to a mobile display unit (20) belonging to the airport surveillance system (15). In other words, the airport surveillance system (15) comprises this mobile display unit (20), so that captured image information from the three camera units (4) of the respective window units (1) can be displayed in a user-defined manner.

In an embodiment of the inventive airport surveillance system (15) not further illustrated, it is also conceivable that the inventive airport surveillance system (15) or its control unit (16) with control program (17) is designed to effect, depending on an evaluation of captured image information of the at least one camera unit (4) from the at least one window unit (1) by means of the control program (17), at least one output-particularly an acoustic, written, or acoustic and written output-on the mobile display unit (20).

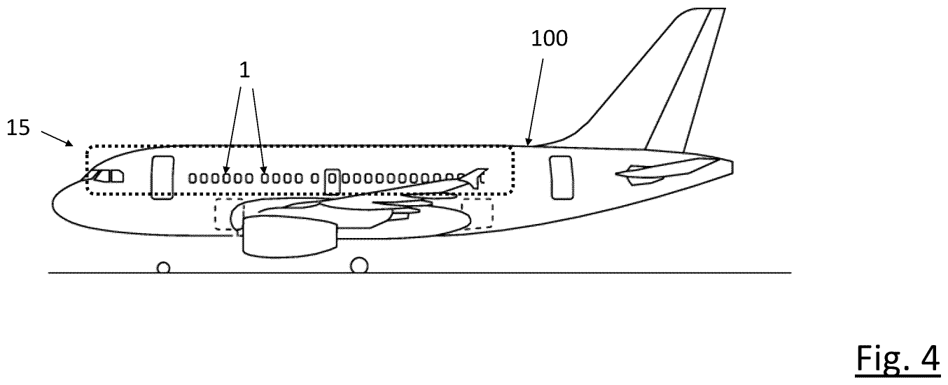

FIG. 4 shows a schematic view of an inventive airplane (100). The airplane (100) is shown both with several inventive window units (1) and with an inventive airport surveillance system (15).

The depicted inventive window units (1) can each be provided either separately or at least partially as part of the depicted airport surveillance system (15). In a further embodiment not further illustrated, it is conceivable, for example, that respective camera units (4), either from respective window units (1) or from respective airport surveillance systems (15), deliver respective image information, wherein subsequently a global evaluation of this image information can be carried out, for example by means of at least one control unit (16) with control program (17), so that a user can be provided not only with an all-round view around the airplane (100) but also with complementary image information merged for a complete view.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

REFERENCE NUMBER LIST

| Reference No. | Description |
|---|---|
| 1 | Window unit |
| 2 | Outer pane |
| 3 | Inner pane |
| 4 | Camera unit |
| 5 | Optics unit |
| 6 | Light ray |
| 7 | First outer side |
| 8 | Second outer side |
| 9 | Field of view |
| 10 | Partial area |
| 11 | Refueling vehicle |
| 12 | Observer |
| 13 | Cut-out region |
| 14 | Frame structure |
| 15 | Airport surveillance system |
| 16 | Control unit |
| 17 | Control program |
| 18 | First connection line |
| 19 | Second connection line |
| 20 | Display unit |
| 100 | Aircraft |

Claimed is:

1. A window unit for an aircraft comprising:
an outer pane;
at least one inner pane; and,
at least one camera unit,
wherein the at least one inner pane is arranged between the outer pane and the at least one camera unit, and
wherein a field of view of the at least one camera unit is aligned only through a partial area of the at least one inner pane,
wherein the at least one inner pane comprises an arrangement of light-reflecting inner-pane-internal material, so that incident light rays through the outer pane are partially guided from at least one coupling-in point on a first outer side of the at least one inner pane, which faces the outer pane, to at least one coupling-out point on a second outer side of the at least one inner pane, which faces an interior of an aircraft in which the window unit is arranged and which is located in the partial area of the at least one inner pane.

2. The window unit according to claim 1, wherein the at least one inner pane has a total surface area that is larger than a total surface area of the outer pane, and
wherein the partial area of the at least one inner pane is provided in a region of the at least one inner pane that does not overlap the total surface area of the outer pane.

3. The window unit according to claim 1, wherein the at least one camera unit is selected from a group consisting of: an image-forming digital camera unit, a thermal-image-generating camera unit, and an infrared-image-generating camera unit.

4. The window unit according to claim 1, wherein the at least one inner pane and the at least one camera unit are arranged in a common frame structure so that the at least one camera unit is configured to be positioned fixed in place relative to the at least one inner pane.

5. The window unit according to claim 1, wherein the at least one inner pane and the arrangement of light-reflecting inner-pane-internal material both comprise at least one plastic, or at least one glass composite, or at least one plastic and at least one glass composite.

6. The window unit according to claim 1, wherein the at least one inner pane has a total surface area larger than a cut-out region of an aircraft fuselage of the aircraft in which the window unit is arranged for the outer pane, and
wherein the partial area of the inner pane is provided in a region of the at least one inner pane that does not overlap the cut-out region.

7. An airport surveillance system for aircraft comprising:
a control unit with a control program; and
at least one window unit of claim 1 coupled to the control unit.

8. The airport surveillance system according to claim 7, further comprising:
at least one mobile display unit configured so that captured image information from the at least one camera unit of the at least one window unit is configured to displayed in a user-defined manner.

9. The airport surveillance system according to claim 7, wherein the control unit is configured to cause, depending on an evaluation of captured image information of the at least one camera unit from the at least one window unit by the control program, at least one output on a display unit.

10. The airport surveillance system according to claim 7, wherein a 360° all-round view around the aircraft is provided by the airport surveillance system.

11. An aircraft comprising:
at least one window unit according to claim 1.
